(19) United States
(12) Patent Application Publication
(10) Pub. No.: US 2005/0109106 A1
(43) Pub. Date: May 26, 2005

(54) Two-piece centering stud for a vehicle wheel balancer

(76) Inventor: Allan H. Hansen, Cornelius, NC (US)

Correspondence Address: Schwartz Law Firm, P.C.;SouthPark Towers, Suite 530, 6100 Fairview Road, Charlotte, NC, 28210, US

(21) Appl. No.: 10/723,348

(22) Filed: Nov. 26, 2003

(51) Int. Cl. G01M 1/02; G01M 1/04

(52) U.S. Cl. 73/487; 301/5.21

(57) ABSTRACT

An elongated centering stud is adapted for attachment to a wheel mounting member applicable for securing a vehicle wheel to a spin balancer. The centering stud includes a head adapted for engaging the vehicle wheel, a body extending from the head, and a base formed with the body opposite the head. The base is adapted for engaging the mounting member. A reduced-diameter connecting end projects from the base, and is adapted for being inserted into a stud-receiving hole formed with the mounting member. The centering stud flexes relative to the mounting member, such that any force acting on the centering stud is distributed along a length of the stud.

### TECHNICAL FIELD AND BACKGROUND OF THE INVENTION

This invention relates generally to vehicle wheel balancing, and more specifically, to an improved centering stud. The centering stud attaches to a flange plate designed for use in an off-vehicle spin balancer applicable for balancing a vehicle wheel. During operation of the spin balancer, the wheel is secured between the flange plate and a locating hub which cooperate to torque and center the wheel on a rotating balancer shaft. The flange plate typically includes between 3 and 8 spaced-apart centering studs which engage the wheel at the lug holes.

Conventional prior art centering studs have an integrally-formed connecting end which inserts into one of several holes pre-formed in the flange plate. These centering studs are specifically designed to be entirely rigid, and to attach to the flange plate without any degree of movement, shifting, or flex. Consequently, as the wheel rotates during balancing, considerable force is applied to the connecting end of the stud and at the stud-receiving hole of the flange plate. To help counter this force, the flange plate is formed of expensive drop forged steel with extremely high tolerances. Despite its hard steel construction, the holes formed in the flange plate become worn and enlarged over a period of normal use. Moreover, if the flange plate is accidentally dropped, the sudden force acting at the connecting end of the centering stud generally damages the stud and deforms the hole. When this occurs, the expensive flange plate must generally be replaced.

The present invention is intended to increase the useful life of the flange plate by providing a centering stud with an enlarged-diameter base and a reduced diameter connecting end. The smaller connecting end allows greater spacing between adjacent holes, thereby increasing the surface area and the structural integrity of the flange plate. In addition, the enlarged base more effectively distributes the force acting at the stud-receiving hole to limit wear and to minimize any deformation if the flange plate is accidentally dropped.

### SUMMARY OF INVENTION

Therefore, it is an object of the invention to provide an improved centering stud for use in a mounting member of a vehicle wheel balancer.

It is another object of the invention to provide a centering stud which helps preserve the high tolerances of the flange plate.

It is another object of the invention to provide a centering stud which limits wear of the stud-receiving hole in the flange plate over a period of use.

It is another object of the invention to provide a centering stud which minimizes any deformation of the stud-receiving hole if the flange plate is accidentally dropped.

It is another object of the invention to provide a centering stud which has an enlarged-diameter base.

It is another object of the invention to provide a centering stud which is formed in two separate pieces which are frictionally held together.

It is another object of the invention to provide a centering stud which is formed in two separate pieces which are held together by mating screw threads.

It is another object of the invention to provide a centering stud which includes a polymer material having natural inherent flex.

It is another object of the invention to provide a centering stud which has sufficient flex to transfer forces otherwise normally applied to the connecting end of the stud.

It is another object of the invention to provide a centering stud which effectively distributes forces along a length of the stud.

It is another object of the invention to provide a centering stud which minimizes damage to its connecting end when the flange plate is dropped.

It is another object of the invention to provide a centering stud which minimizes damage to the stud-receiving hole in flange plate when the flange plate is dropped.

It is another object of the invention to provide a centering stud which has an internal cavity defining a flex region which enables slight flexing of the stud relative to the flange plate.

It is another object of the invention to provide centering stud which includes a base which is larger in diameter than its wheel-engaging head.

These and other objects of the present invention are achieved in the preferred embodiments disclosed below by providing an improved elongated centering stud. The centering stud is adapted for attachment to a wheel mounting member applicable for securing a vehicle wheel to a spin balancer. The centering stud includes a head adapted for engaging the vehicle wheel, a body extending from the head, and a base formed with the body opposite the head. The base is adapted for engaging the mounting member. A reduced-diameter connecting end projects from the base, and is adapted for being inserted into a stud-receiving hole formed with the mounting member. Means are provided for flexing the centering stud relative to the mounting member, such that any force acting on the centering stud is distributed along a length of the stud.

The term “flexing” refers broadly to any movement of the centering stud relative to the mounting member. Preferably, the mounting member is a flange plate.

According to another preferred embodiment of the invention, the base and body define a longitudinally-extending internal cavity.

According to another preferred embodiment of the invention, the internal cavity extends more than 5% of the entire length of the centering stud.

Preferably, the internal cavity extends more than 50% of the entire length of the centering stud.

According to another preferred embodiment of the invention, an elongated reinforcement pin is received within the internal cavity. The pin has a free end which projects from the base and defines the connecting end of the centering stud.

According to another preferred embodiment of the invention, the internal cavity defines an enlarged-diameter flex region extending inwardly from the base. The flex region allows slight movement of the base relative to the reinforcement pin. This movement allows slight flexing of the centering stud relative to the mounting member.

According to another preferred embodiment of the invention, the flex region extends more than 5% of the entire length of the cavity.

Preferably, the flex region extends between 25% and 50% of the entire length of the cavity.

According to another preferred embodiment of the invention, the diameter of the base is more than 3.5 times the diameter of the connecting end. This enlarged-diameter base protects the stud-receiving opening of the mounting member against deformation caused by operation of the spin balancer.

According to another preferred embodiment of the invention, the diameter of the base is more than 12.5% larger than a maximum diameter of the head.

According to another preferred embodiment of the invention, the head has a beveled locating tip for locating the centering stud in a lug hole of the vehicle wheel.

According to another preferred embodiment of the invention, the connecting end defines an annular groove adapted for receiving an O-ring to frictionally engage the mounting member at the stud-receiving opening.

According to another preferred embodiment of the invention, the head, body and base are integrally-formed together of a molded polymer material.

In another embodiment, the invention is an elongated centering stud including a head adapted for engaging the vehicle wheel, a body extending from the head, and a base formed with the body opposite the head. The base is adapted for engaging the mounting member. The base and body define a longitudinally-extending internal cavity. An elongated reinforcement pin is received within the internal cavity. The pin has a free end which projects from the base, and is adapted for being inserted into a stud-receiving hole formed with the mounting member.

In yet another embodiment, the invention is an elongated centering stud including a head adapted for engaging the vehicle wheel, a body extending from the head, and a base formed with the body opposite the head. The base is adapted for engaging the mounting member. A reduced-diameter connecting end projects from the base, and is adapted for being inserted into a stud-receiving hole formed with the mounting member. The diameter of the connecting end is less than one-third the diameter of the base. The enlarged-diameter base protects the stud-receiving opening of the mounting member against deformation caused by operation of the spin balancer.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is perspective view of a wheel centering stud according to one preferred embodiment of the present invention;

FIG. 2 is an environmental view of the centering stud;

FIG. 3 is a further environmental view of the centering stud;

FIG. 4 is a side view of the centering stud;

FIG. 5 is an exploded view of the centering stud showing the reinforcement pin removed from the internal cavity;

FIG. 6 is a cross-sectional view of the centering stud with the reinforcement pin removed to best illustrate a flex region of the cavity;

FIG. 7 is a perspective view of a centering stud according to a second preferred embodiment; and

FIG. 8 is an exploded view of the centering stud shown in FIG. 7.

### DESCRIPTION OF THE PREFERRED EMBODIMENT AND BEST MODE

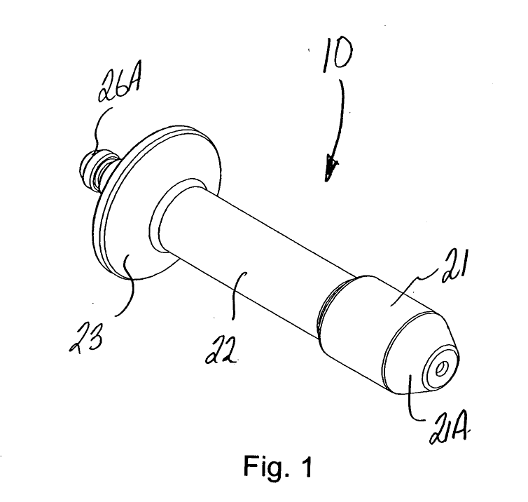

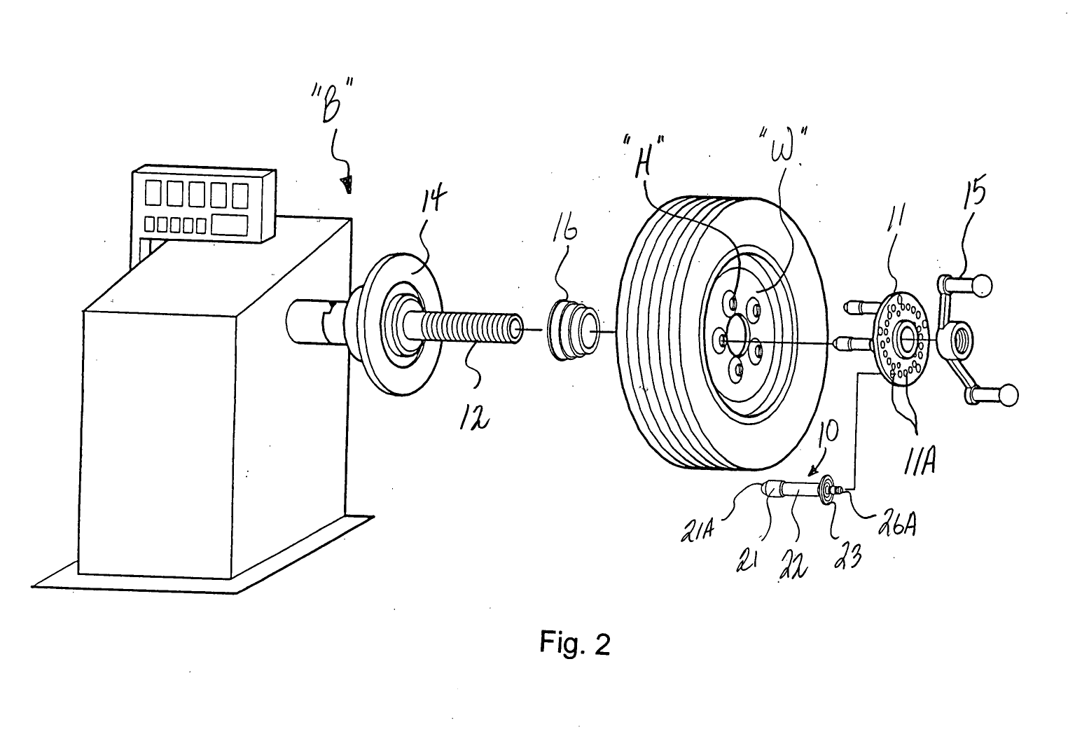

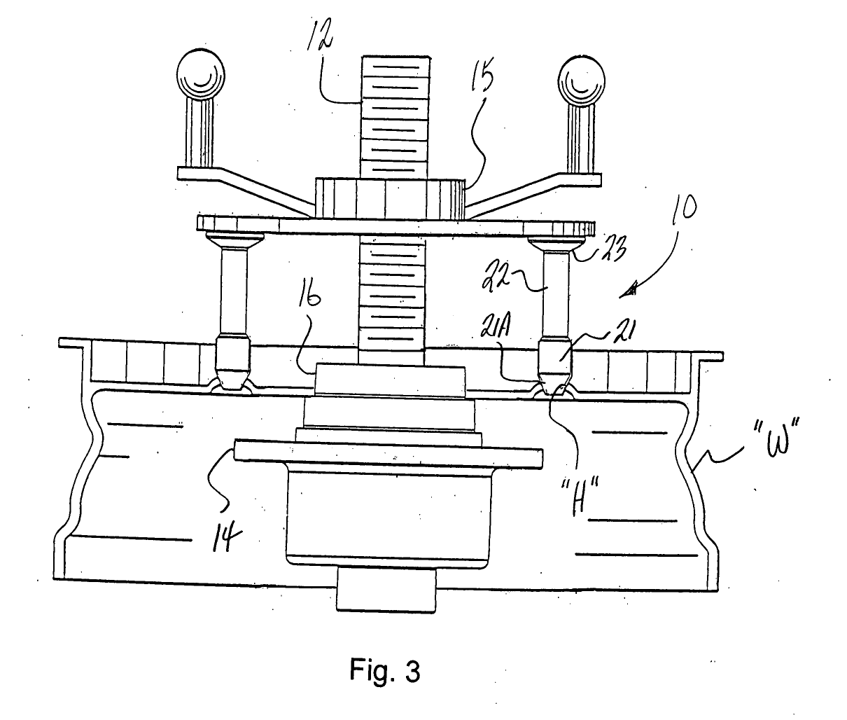

Referring now specifically to the drawings, a wheel centering stud according to the present invention is illustrated in FIG. 1, and shown generally at reference numeral 10. The centering stud 10 is attached to a flange plate 11, shown in FIGS. 2 and 3, applicable for use in an off-vehicle spin balancer “B” adapted for balancing a vehicle wheel “W”. Generally, 3 to 8 centering studs 10 are used to mount and center the wheel “W” on the spin balancer “B”. The balancer “B” incorporates a mid-centering device including a horizontal steel mounting shaft 12 which extends through a center hole of the wheel “W”, and a locating hub 14 comprising an annular face plate against which the wheel “W” is torqued prior to balancing. A conventional wingnut tightener 15 is applied to a threaded end of the mounting shaft 12 to urge the flange plate 11 inwardly towards the vehicle wheel “W”. The centering studs 10, described below, engage the wheel “W” at respective lug holes “H”, and cooperate with a centering cone 16 to both statically and dynamically center the wheel “W” on the mounting shaft 12. The mounting shaft 12 is operatively connected to an electric drive motor which rotates the shaft 12 and wheel “W” during balancing.

Centering Stud 10

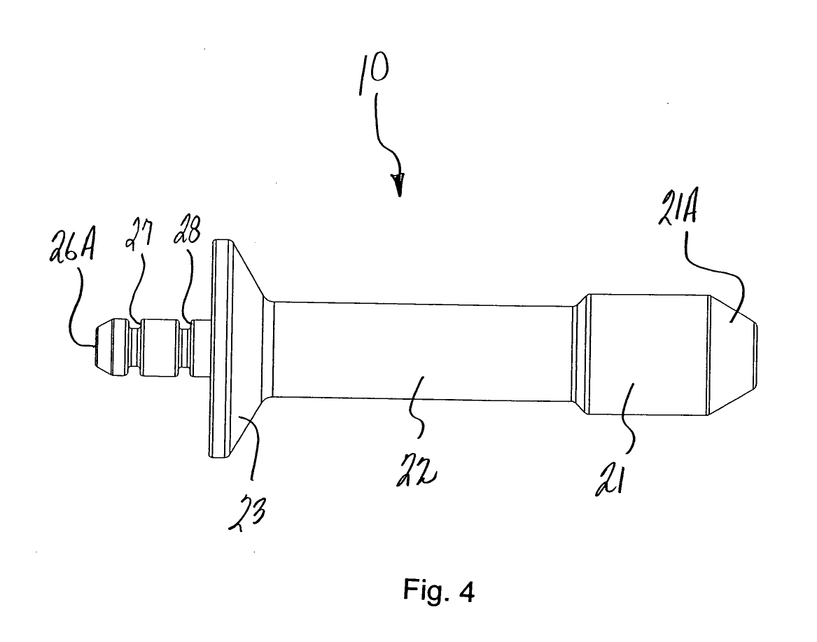

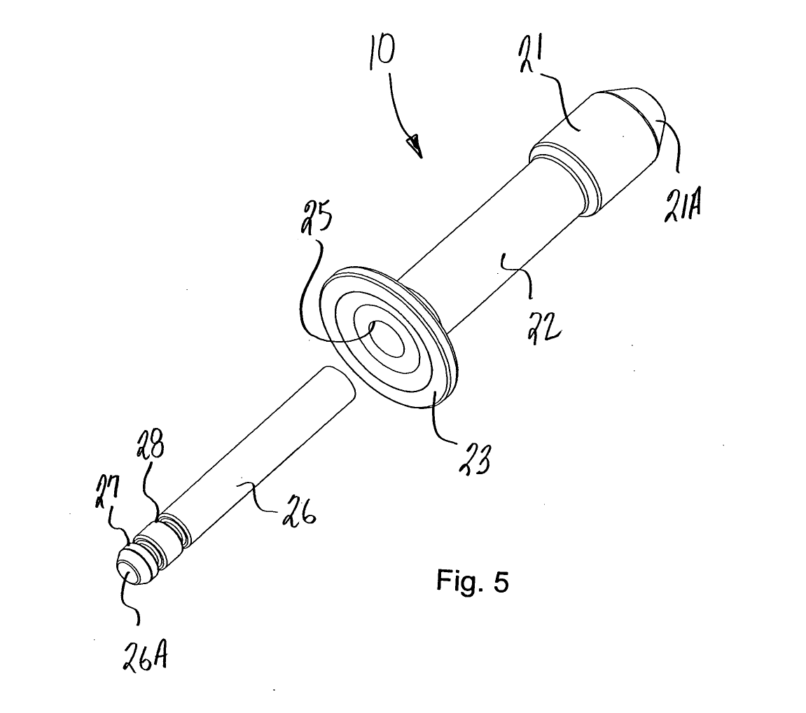

Referring to FIGS. 1, 2, 4, 5, and 6, the centering stud 10 comprises a wheel-engaging head 21, a cylindrical body 22, and an enlarged base 23 integrally-formed together of steel or other hard metal. The body 22 and base 23 define a longitudinally-extending internal cavity 25. The cavity 25 is designed to receive a separate, elongated, steel reinforcement pin 26. The pin 26 is frictionally secured inside the cavity 25, and has a relatively small diameter free end 26A which projects from the enlarged stud base 23 and inserts into one of several stud-receiving holes 11A formed in the flange plate 11 (See FIG. 2). A typical flange plate 11 may include 30 or more spaced-apart holes 1 1A. Multiple plate holes 11A are required to accommodate different arrangements of centering studs 10 applicable for various wheel designs. The greater the number of holes 11A, the more universal the flange plate 11.

Preferably, resilient O-rings (not shown) are located within respective annular grooves 27 and 28 of the pin 26 to frictionally attach the centering stud 10 to the flange plate 11 such that the stud 10 can be readily removed and re-inserted into any selected plate hole 11A. The diameter of each plate hole 11A is only slightly larger than the diameter of the connecting end 26A. Consequently, the relatively small plate holes 11A can be spaced apart a greater distance from each other in an otherwise conventional plate design. The flange plate 11 may also include additional holes 11A to serve a wider range of wheel designs. The diameters of the connecting end 26A and plate holes 11A are approximately 9 mm (+/−), as compared to 11 mm for conventional studs and flange plates. This smaller diameter allows more than 2 mm spacing between each of 36 holes in a flange plate. One conventional flange plate has a 36-mm diameter center hole and approximately 265 cm² of available surface area to form the stud-receiving holes.

As best shown in FIGS. 2 and 3, the head 21 of the stud 10 has a beveled locating tip 21A which fits into a lug hole in the wheel “W”. Beyond the locating tip 21A, the maximum size of the stud head 21 is sufficiently larger than the diameter of the lug hole to prevent penetration of the stud 10 through the wheel hub “H”. With the flange plate 11 urged tightly against the wheel “W”, as previously described, the spin balancer “B” operates to rotate the wheel “W” about an axis defined by the mounting shaft 12. In a standard centering stud, considerable force is concentrated at its plate-connecting end during operation of the balancer. Over a period of normal use, the stud-receiving hole in the flange plate and/or plate-connecting end of the stud becomes worn and unusable. In some cases, the entire flange plate must be replaced.

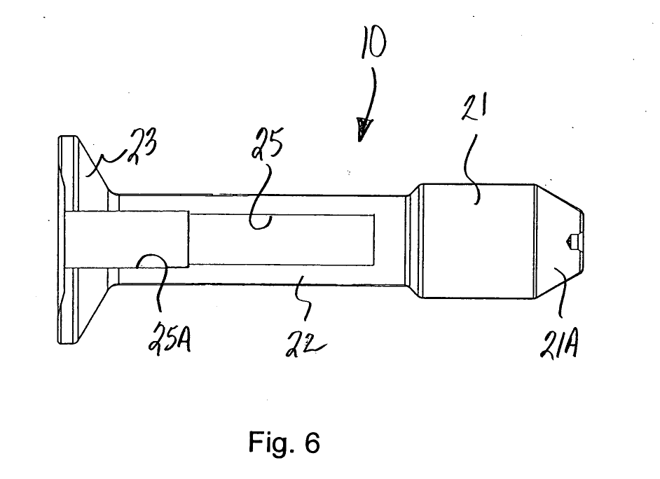

To help counter this problem, the present centering stud 10 has a relatively small connecting end 26A which allows greater spacing between adjacent plate holes 11A, as mentioned above. This added surface area increases the structural integrity of the flange plate 11 at each of the holes 11A. Moreover, as shown in FIG. 6, the internal cavity 25 of the centering stud defines a longitudinal flex region 25A of slightly increased diameter which allows the stud base 23 to shift relative to the reinforcement pin 26. This shifting allows the centering stud 10 to “flex” slightly relative to the flange plate 11, thereby distributing forces applied to the centering stud 10 throughout the length of the reinforcement pin 26. Preferably, the flex region 25A extends from the base 23 of the stud 10 along approximately 40% of the entire length of the cavity 25.

In addition to the above, the enlarged stud base 23 provides increased surface area in contact with the flange plate 11 to better distribute forces acting at the plate hole 11A. Preferably, the diameter of the enlarged base 23 contacting the flange plate 11 is more than 3.5 times larger than the diameter of the connecting end 26A, more than 3.5 times larger than the diameter of the stud-receiving hole 11A, and more than 2.5% larger than the maximum diameter of the head 21. According to one specific embodiment, the diameter of the stud base 23 is approximately 34 mm, the diameter of the connecting end 26A approximately 9 mm, and the maximum diameter of the head 21 approximately 24 mm.

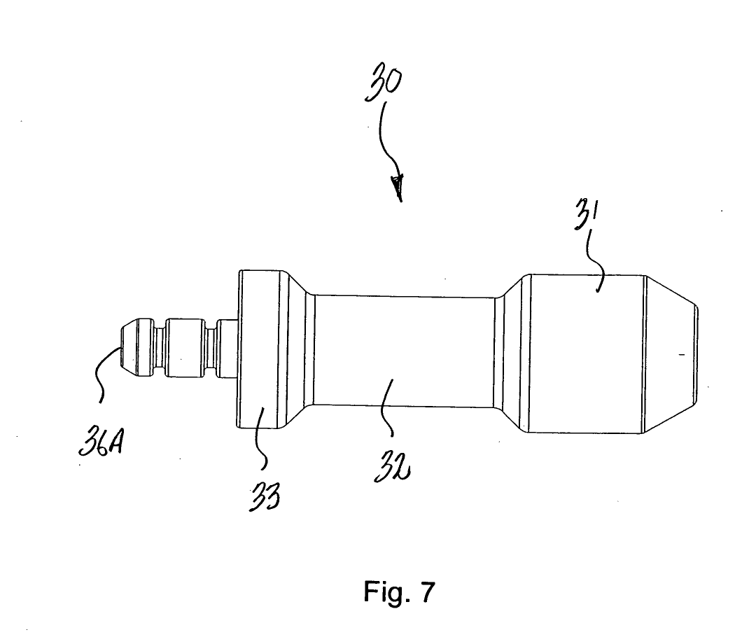

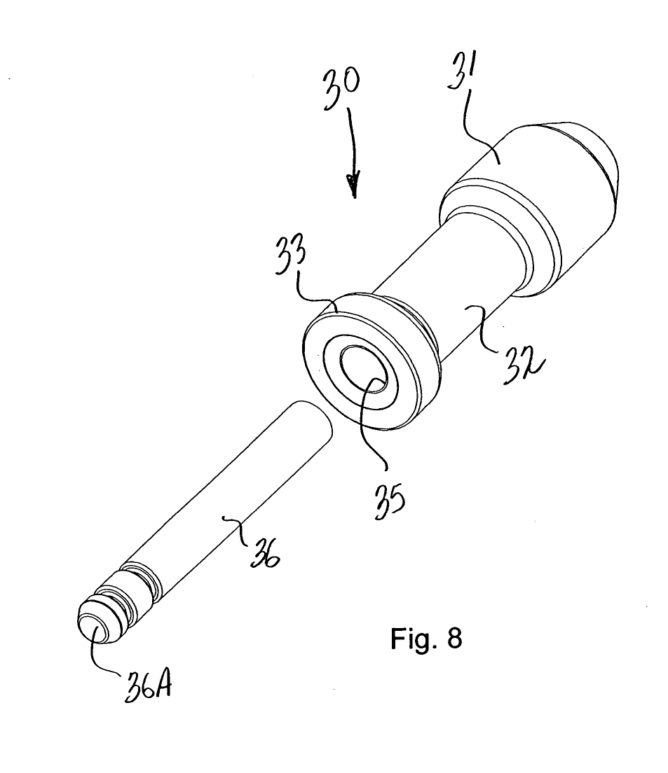

A further embodiment of a two-piece centering stud 30 according to the present invention is illustrated in FIGS. 7 and 8. The centering stud 30 includes a wheel-engaging head 31, a cylindrical body 32, and standard size base 33 integrally formed together of a molded polymer. The body 32 and base 33 define a longitudinally-extending internal cavity 35. The cavity 35 is designed to receive a separate, elongated, steel reinforcement pin 36. The pin 36 is frictionally secured inside the cavity 35, and has a relatively small diameter free end 36A which projects from the stud base 33 and inserts into one of several stud-receiving holes formed in the flange plate. According to one embodiment, the diameters of the base 33, connecting end 36A, and head 31 are 24 mm, 9 mm, and 24 mm, respectively.

A wheel centering stud is described above. Various details of the invention may be changed without departing from its scope. Furthermore, the foregoing description of the preferred embodiment of the invention and best mode for practicing the invention are provided for the purpose of illustration only and not for the purpose of limitation-the invention being defined by the claims.

1. An elongated centering stud adapted for attachment to a wheel mounting member applicable for securing a vehicle wheel to a spin balancer, said centering stud comprising:
(a) a head adapted for engaging the vehicle wheel;
(b) a body extending from said head;
(c) a base formed with said body opposite said head, and adapted for engaging the mounting member;
(d) a reduced-diameter connecting end projecting from said base and adapted for being inserted into a stud-receiving hole formed with the mounting member; and
(e) means for flexing said centering stud relative to the mounting member, such that any force acting on said centering stud is distributed along a length of said stud.

2. A centering stud according to claim 1, wherein said base and body define a longitudinally-extending internal cavity.

3. A centering stud according to claim 2, wherein said internal cavity extends more than 5% of the entire length of the centering stud.

4. A centering stud according to claim 2, and comprising an elongated reinforcement pin received within said internal cavity, and having a free end projecting from said base and defining said connecting end of said centering stud.

5. A centering stud according to claim 4, wherein said internal cavity defines an enlarged-diameter flex region extending inwardly from said base, and adapted to allow movement of said base relative to said reinforcement pin and flexing of said centering stud relative to the mounting member.

6. A centering stud according to claim 5, wherein said flex region extends more than 5% of the entire length of said cavity.

7. A centering stud according to claim 1, wherein the diameter of said base is more than 3.5 times the diameter of said connecting end, whereby the enlarged-diameter base protects the stud-receiving opening of the mounting member against deformation caused by operation of the spin balancer.

8. A centering stud according to claim 1, wherein the diameter of said base is more than 12.5% larger than a maximum diameter of said head.

9. A centering stud according to claim 1, wherein said head comprises a beveled locating tip for locating said centering stud in a lug hole of the vehicle wheel.

10. A centering stud according to claim 1, wherein said connecting end defines an annular groove adapted for receiving an O-ring to frictionally engage the mounting member at the stud-receiving opening.

11. A centering stud according to claim 1, wherein said head, body and base are integrally-formed together of a polymer material.

12. An elongated centering stud adapted for attachment to a wheel mounting member applicable for securing a vehicle wheel to a spin balancer, said centering stud comprising:
(a) a head adapted for engaging the vehicle wheel;
(b) a body extending from said head;
(c) a base formed with said body opposite said head, and adapted for engaging the mounting member;
(d) said base and body defining a longitudinally-extending internal cavity; and
(e) an elongated reinforcement pin received within said internal cavity, and comprising a free end projecting from said base and adapted for being inserted into a stud-receiving hole formed with the mounting member.

13. A centering stud according to claim 12, wherein said internal cavity extends more than 5% of the entire length of the centering stud.

14. A centering stud according to claim 12, wherein said internal cavity defines an enlarged-diameter flex region extending inwardly from said base, and adapted to allow movement of said base relative to said reinforcement pin and flexing of said centering stud relative to the mounting member.

15. A centering stud according to claim 14, wherein said flex region extends more than 5% of the entire length of said cavity.

16. A centering stud according to claim 12, wherein the diameter of said base is more than 3.5 times the diameter of said connecting end, whereby the enlarged-diameter base protects the stud-receiving opening of the mounting member against deformation caused by operation of the spin balancer.

17. A centering stud according to claim 12, wherein the diameter of said base is more than 12.5% larger than a maximum diameter of said head.

18. A centering stud according to claim 12, wherein said head comprises a beveled locating tip for locating said centering stud in a lug hole of the vehicle wheel.

19. A centering stud according to claim 12, wherein the free end of said reinforcement pin defines an annular groove adapted for receiving an O-ring to frictionally engage the mounting member at the stud-receiving opening.

20. An elongated centering stud adapted for attachment to a wheel mounting member applicable for securing a vehicle wheel to a spin balancer, said centering stud comprising:
(a) a head adapted for engaging the vehicle wheel;
(b) a body extending from said head;
(c) a base formed with said body opposite said head, and adapted for engaging the mounting member; and
(d) a reduced-diameter connecting end projecting from said base and adapted for being inserted into a stud-receiving hole formed with the mounting member, and the diameter of said connecting end being less than one-third the diameter of said base, whereby the enlarged-diameter base protects the stud-receiving opening of the mounting member against deformation caused by operation of the spin balancer.
